(19) United States
(12) Patent Application Publication
(10) Pub. No.: US 2006/0156343 A1
(43) Pub. Date: Jul. 13, 2006

(54) Method and system for media and similar downloading

(76) Inventor: Edward Jordan, Belle Mead, NJ (US)

Correspondence Address: KAPLAN GILMAN GIBSON & DERNIER L.L.P., 900 ROUTE 9 NORTH, WOODBRIDGE, NJ, 07095, US

(21) Appl. No.: 11/031,164

(22) Filed: Jan. 7, 2005

(51) Int. Cl. H04N 7/16; H04N 7/173; H04N 5/445; G06F 13/00

(52) U.S. Cl. 725/50; 725/132; 725/140; 725/152

(57) ABSTRACT

A method and system are provided for facilitating downloading a medium, such as a song, a movie, a TV show, a commercial, etc., that is being streamed from a media station and played on a receiver. By actuating a button on the receiver, a request for downloading the medium is sent to a management server together with an identifier of the medium. The requested medium is located in a media database and downloaded to a temporary storage allocated by the management server for later downloading to a personal computer or a portable media playing device. If the medium is a commercial, the request may include an order for the merchandise advertised in the commercial.

### TECHNICAL FIELD OF THE INVENTION

The present invention relates to media downloading techniques, and more particularly, to a method and system for facilitating downloading media, such as songs, movies, TV programs, and the like that are received from media stations and being played on receivers. It is also applicable to product sales.

### BACKGROUND OF THE INVENTION

Through a radio receiver in a home stereo or a car stereo, people often enjoy songs broadcasted and/or received from radio stations. As to conventional radio stations that broadcast analog signals, listeners usually get information (such as title, artist's name, etc) of the songs playing on the receiver by listening to the announcer's explanation to the songs. With the development of digital technologies, satellite radio stations and HD radio stations can digitally transmit songs, together with more information about the playing songs to the radio receivers which may include the title, artist's name, album's name, etc., of each song that is being played. Also there are numerous net radio stations that deliver music over the Internet to personal computers, which also conveniently provide information about the songs to be displayed to the listeners.

Often a listener has a desire to download a song playing on the receiver or computer so he or she can enjoy the song later, preferably with a better quality than the streaming one. To do so, he has to write down the song's information such as title, artist's name, etc, and download it later from a downloading service provider (such as iTune). This is very inconvenient, and may be impossible if the listener hears the song from a car stereo when he is on the move. Also, the user may not know the name of the song—merely that he hears a tune that he likes.

Though some receivers have recording capability to recording the songs from the stream, however, they have to record whatever that has been received from the radio stations (which may include commercials), and it is always too late if the listener decides to record a song after he or she hears it.

Similar problems exists in other types of streaming media, such as TV programs, movies, etc. For example, people usually use VHS recorders or Tivo to record movies or other TV programs that are aired on TV. In order not to miss part of the movie or other aired TV programs, people have to schedule the recording before the movies or programs are aired. However, often people have not decided to record the movies or programs until they have been watching the movies or TV programs for a while. Moreover, the movies recorded from the stream are always not in a high quality, while people often have a desire to recorded their favorite ones in a superior quality.

Therefore, there exists a need of a convenient method and system to download a streaming medium (such as a song, a movie, a TV program, etc.,) that is being received and played on a receiver so that it can be enjoyed again later, and preferably in a higher quality.

### SUMMARY OF THE INVENTION

According to a first aspect of the present invention, a method for facilitating downloading media is provided, which comprises steps of: receiving at a receiver a stream of media together with an identifier for each medium in the stream from a media station; sending a request from the receiver to a management server for downloading one of the media in the stream, the request including the identifier of the requested medium; and downloading the requested medium from a media database to a destination.

According to a second aspect of the present invention, a system for facilitating downloading media is provided, which comprises: a receiver for receiving, from a media station, a stream of media and an identifier for each of the media in the stream, the receiver comprising means for sending out a request for downloading one of the media in the stream, the request including the identifier identifying the requested medium; a management server for receiving the request; and a media database for transmitting the requested media to a destination.

According to a third aspect of the present invention, a receiver for receiving and playing a stream of media from at least one media station is provided, which comprises means for receiving an identifier for identifying each of the media in the stream, and means for sending a request to a management server for downloading one of the media in the stream identified by the identifier which is included in the request.

With the present invention, a request for downloading a medium can be sent, together with the identifier of the medium, directly from the media receiver to the management server while the medium is playing on the receiver. The user does not need to write down the title, artist's name or other identification information of the medium for a later downloading.

Preferably, the requested media are downloaded from the media database to a temporary storage maintained by the management server, so that the requester can download the media from the temporary storage to a personal device (e.g., a computer, a portable music player, etc.) at a later time.

The media database may be maintained by a third party downloading service provider. Alternatively, the media database is maintained by the management server. Alternatively, the media database is maintained by the media station from which the requested medium is streamed and received on the receiver.

Alternatively, the management server authenticates the receiver each time it receives a request from the receiver.

The requested media may be audio media (such as speech, songs, music, etc.), video media or multimedia (such as movies, TV programs, etc.) or text media (such as caption in the TV programs, the subtitles in the movies, etc.) that received from radio stations, TV stations, satellite media stations, multimedia servers, etc.

The invention is also applicable to non-media downloading.

### BRIEF EXPLANATION OF THE DRAWINGS

The above and other features and advantages of the present invention will become clearer after reading the detailed description of the preferred embodiments according to the present invention with reference to the accompanying drawings in which:

FIG. 1 schematically illustrates an embodiment of the system according to the present invention;

FIG. 2 illustrates an exemplary in-dash receiver of a car stereo incorporated in the embodiment of FIG. 1 according to the present invention;

FIG. 3 is a flow chart schematically illustrating an operational steps implemented by the embodiment in FIG. 1 according to the present invention; and

FIG. 4 schematically illustrates another embodiment of the system according to the present invention.

### DETAILED EXPLANATION OF THE INVENTION

The present invention will be described in detail below with the preferred embodiments for downloading songs. It shall be understood, however, that the principle of the present invention is also equally applicable to downloading other types of media such as TV programs, movies, text, etc.

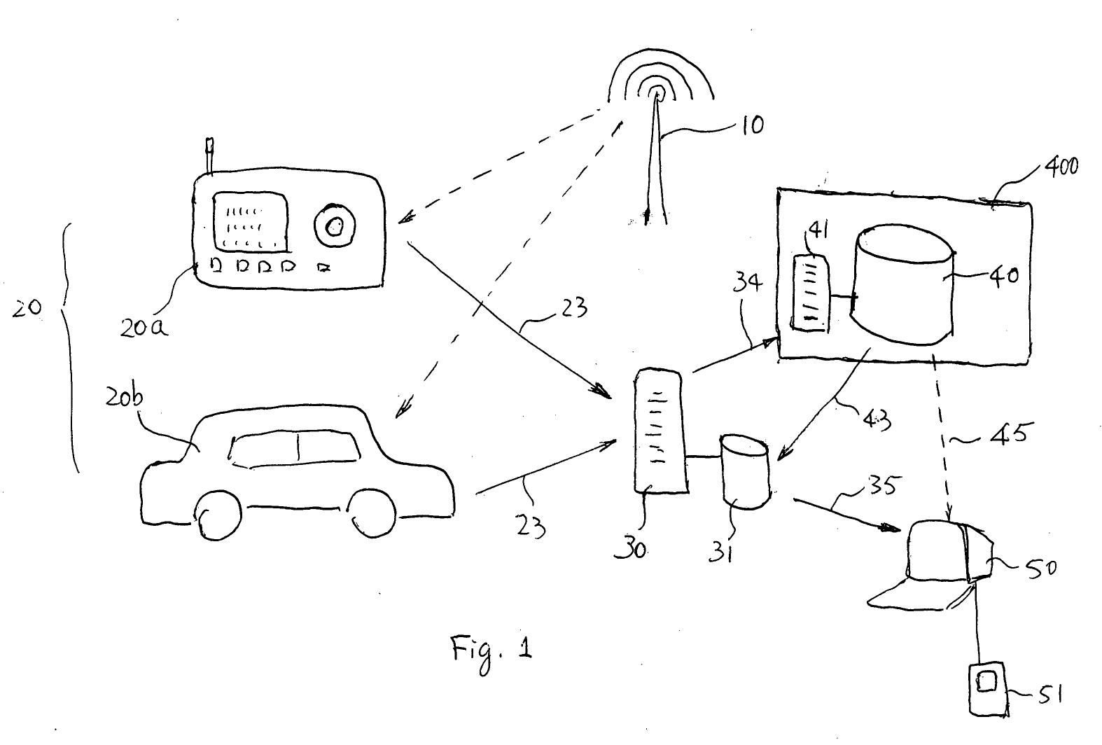

FIG. 1 schematically illustrates an embodiment of the system according to the present invention. In this embodiment, the receiver 20 is a radio receiver such as a portable radio receiver 20a or an in-dash radio receiver 20b of a car stereo, and can receive and play a stream of songs from a radio station 10. The radio station 10 can be a conventional radio station that broadcasts songs by analog signals, or a satellite or HD radio station that transmits songs digitally. Accordingly, the radio receiver 20a, 20b can be a conventional analog radio receiver for receiving analog songs from conventional radio stations. Preferably, however, the radio receiver is an advanced digital radio receiver that is capable of receiving digital songs from satellite radio stations or HD radio stations or other types of digital radio stations. Usually a digital radio receiver is designed to be also capable of receiving analog songs from the conventional radio stations.

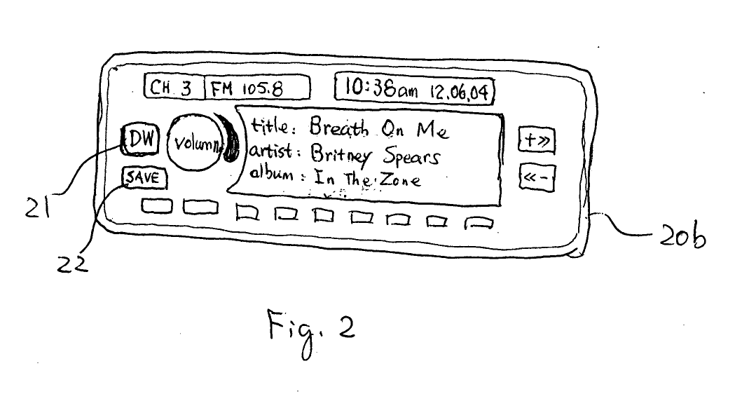

In a preferred embodiment, the radio receiver 20a, 20b is a digital radio receiver that is capable of receiving songs from one or more digital radio stations 10. According to the teaching of the present invention, a radio receiver (such as an exemplary in-dash radio receiver 20b shown in FIG. 2) is provided with a download button 21 in addition to its conventional functional buttons. When a song from the radio station 10 is being played in the radio receiver 20b, some information about the song, such as the title, the artist's name, the album's name, etc., is also available at the radio receiver 20b. If a listener is attracted by the song and wants to download it for later listening, he can simply press the button 21 when the song is on the air, and a request for downloading the song will be sent out to a management server 30, as explained in more detail below.

Returning to FIG. 1, upon pressing or actuating the button 21 on the radio receiver 20a or 20b, the request for downloading the song is sent out to a management server 30 over a communications connection 23. The communications connection 23 can be a connection over a wireless network or over a data network such as Internet. The request includes an identifier that identifies the song that the listener desires to download. Preferably, the identifier of the song includes the title of the song. Preferably, the identifier of the song further includes the artist's name and/or the album's name of the song. If the radio station 10 is a satellite radio station or a HD radio station, and the radio receiver 20a or 20b has a capability to receive the digital signals, these song's information is also transmitted, together with the song, from the radio station 10 to the radio receiver 20a, 20b, and is usually displayed on the receiver 20a, 20b when the song is being played.

After receiving the request which includes the song's identifier, the management server 30 forwards the request to a downloading service provider 400 over a communications connection 34. The downloading service provider 400 maintains a music database 40 controlled by a server 41. Upon receiving the downloading request forwarded from the management server 30, the server 41 runs a proper program to locate, at the music database 40, the requested song identified by the identifier included in the request.

Then the requested song is transmitted from the music database 40 to a destination, possibly to a temporary storage 31 maintained by the management server 30 and allocated to the requester (the listener) for his or her later downloading to a personal computer 50 over a connection 35 over a data network when the requester has a chance to get online. Preferably, the song is further downloaded to a portable music player 51, such as an iPod.

Alternatively, the requested song can be uploaded, through a data connection 45, directly from the downloading service provider 400 to the personal computer 50 of the requester. For example, a FTP server can be set up on the personal computer 50 for automatically receiving the song transferred from the downloading service provider 400. The address and account information of the FTP server of the requester may be provided to the management server 30 when the requester subscribes the service provided by the management system 30 and selects the downloading destination (the temporary storage or the FTP server, etc.), the information of which is provided by the management server 30 to the downloading service provider 400 when the management server 30 forwards the downloading request to the downloading service provider 400.

Preferably, the radio receiver 20a or 20b subscribes with the management server 30 for the downloading service as explained above. After registering an account with the management server 30, the radio receiver 20a or 20b can be remotely configured to be able to use the service. Each time a request is received by the management server 30, the management receiver 30 will authenticate the radio receiver 20a, 20b. After the requested song is successfully downloaded, a charge will be applied to the account associated with the radio receiver 20a, 20b. In addition to charging the consumer for the song, the service provider that facilitates the one button convenient download can also be paid a fee.

In an alternative embodiment, the identifiers of the interesting songs may be temporary saved in the radio receiver 20, e.g., by pressing a “SAVE” button 22 (FIG. 2). Preferably, the saved identifiers can be browsed and selectively deleted. At a later time, the listener can press on button 21 and send a single request, for example, to the management server 30, which includes all the identifiers that have been temporarily saved and have not been deleted yet.

In an alternative embodiment, the radio station 10 is a conventional radio station that broadcasts analog songs to the radio receiver 20a, 20b. Thus, the information of the songs are not available on the receiver 20a, 20b, except that the listener hears from the radio. In this case, the identifier of the song will be a time stamp when the song is being played. More specifically, when the listener presses the downloading button 21 to request downloading the song that he is listening to, a time stamp indicating the time when the button is actuated is included in the request as an identifier of the requested song. Upon receiving the request, the management receiver 30 can acquire the information (title, artist, album, etc) of the song from the radio station 10. Preferably, the radio station 10 maintains a scheduled playlist for the songs that it broadcasts and provides such a playlist to the management server 30. After identifying the song with the time stamp against the playlist and obtains the information of the songs, the management server 30 then forwards the request to the downloading service provider 400, together woth the obtained information (title, artist, album, etc) of the requested song, to proceed the downloading process as explained above. In this embodiment, the conventional radio station 10 and the radio receiver 20a, 20b do not need to have a capability of digitally transmitting or receiving songs.

The management server 30, the downloading service provider 400 and the radio station 10 can be entities independent of each other. Alternatively, two or all of them can be the same entity. For example, the radio station 10 may maintain the management server 30 (which will be particularly advantageous in the conventional radio station embodiment explained above), while the downloading service provider 400 can be an independent entity, such as iTune. Thus, the request to download can go directly to the radio station 10, which can then facilitate the transmission of the song title or other information necessary to download the song to the downloading service provider 400. Preferably, the downloading service provider 400 is the radio station 10. This may be convenient because the requested songs are always available in the radio station 10 from which the listener hears the songs. Alternatively, the downloading service provider 400 maintains the management server 30, which, in this case, may eliminate the need of the server 41 and the temporary storage 31.

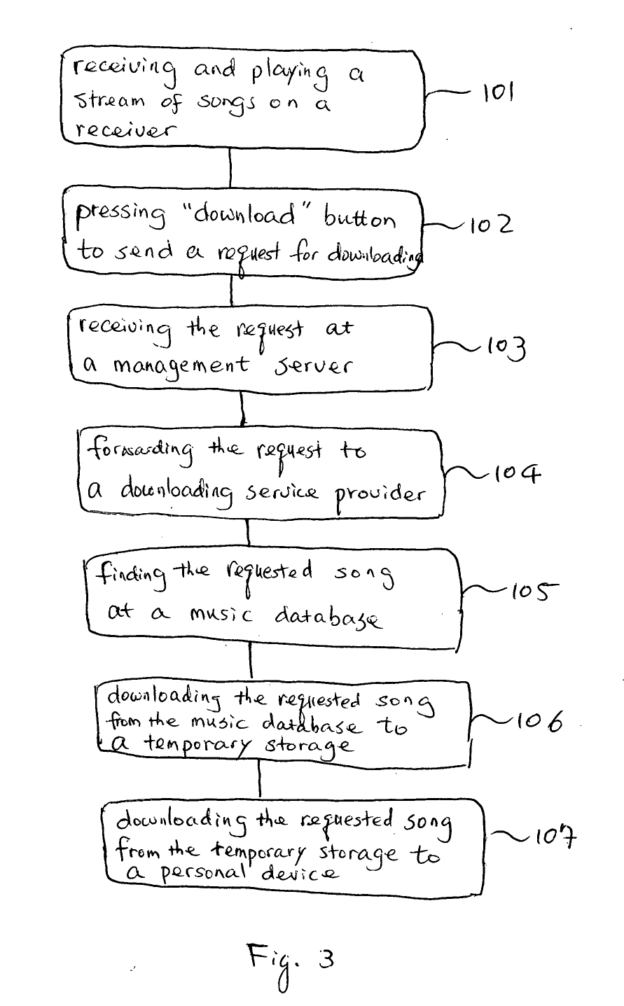

FIG. 3 shows exemplary operational steps of the system as illustrated in FIG. 1. At step 101, the radio receiver 20a, 20b receives and plays a stream of songs from a radio station 10. When the listener hears an interesting song and desires to download it for later listening, the listener press the download button 21 at step 102 to send a request for downloading. The management server 30 receives the request at step 103, and then forwards the request to the downloading service provider 400 at step 104. With the identifier included in the request, the downloading service provider 400 locates the requested song at the music database 40 that it maintains, at step 105. The requested song is first downloaded to a temporary storage 31 that the management server 30 allocates to the requester, at step 106, and is finally downloaded or forwarded to a personal computer 50 or a portable music player 51, at step 107.

It shall be understood that the steps shown in FIG. 3 are only exemplary but not limiting. Some steps may be omitted in some circumstances. For example, the forwarding step 4 may be not necessarily if the downloading service provider 400 and the management server 30 are the same entity.

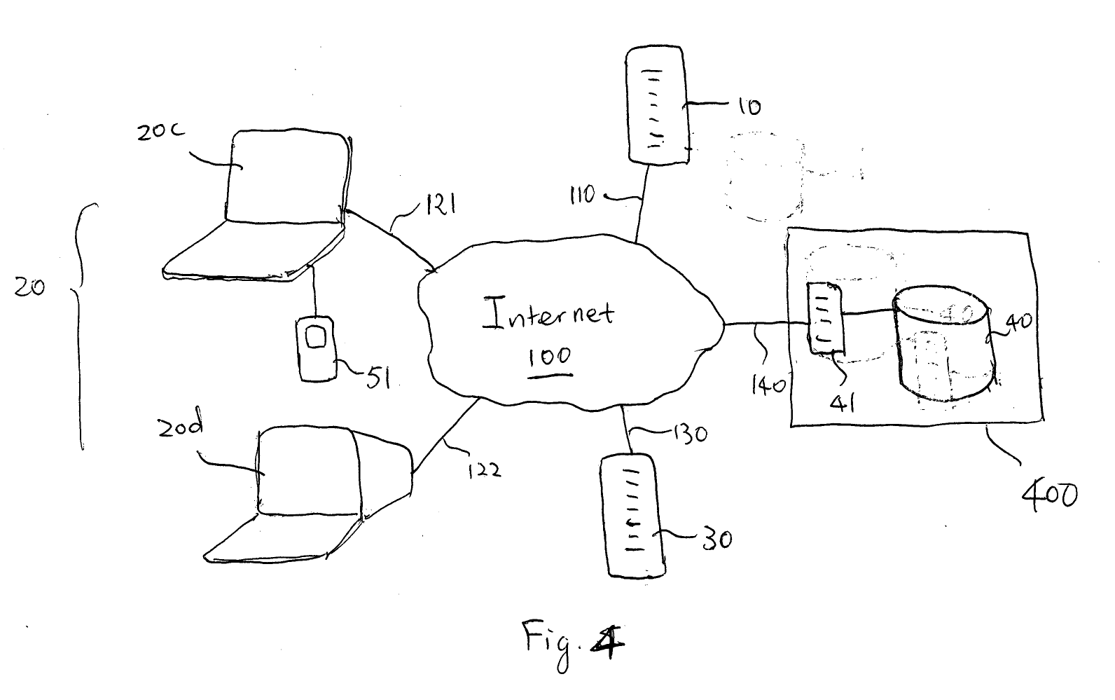

FIG. 4 illustrates another embodiment of the system according to the present invention in a net radio scenario. As illustrated in FIG. 4, the net radio station 10 broadcasts songs, through a data connection 110 and Internet 100, to end users represented by personal computers such as a laptop computer 20c or a desktop computer 20d. The personal computers 20c, 20d may get connected to the Internet 100 over data connections 121, 122 which can be a wireless data connection, an Ethernet connection, or any other proper data connections.

When an end user is listening to songs streaming from the net radio station 10 and wants to download the song that he is hearing, he may click on a button provided on a music player application to send out a request for downloading the song. The request includes an identifier (e.g., title, the name of artist, the name of album, etc.) of the song, which are usually also transmitted and displayed on the music player application. The request is transmitted over Internet 100 to a management server 30 connected to Internet over a data connection 130. Upon receiving the request, the management server 30 forwards the request to a downloading service provider 400 which maintains a music database 40 controlled by a server 41. With the identifier included in the request, the downloading service provider 400 locates the requested song at the music database 40 and transmits the same to the requesting computer 20c, 20d through the management server 30, or directly to the requesting computer 20c, 20d if the downloading service provider 400 has the address of the requesting computer 20c, 20d. The user may also further download the song to his or her portable music player 51 from the computer 20c, 20d.

Preferably, the management server 30 and the downloading service provider 400 are the same entity. Alternatively, the net radio station 10 may maintain the music database 40. Alternatively, the net radio station 10, the management server 30 and the downloading service provider 400 may be a single entity.

In a further embodiment, the audio stream received from the radio station 10 can be a commercial, and pressing on the downloading button 21 while listening to the commercial will send a request to the management server 30. This request may include a request to download an audio file of the commercial. Preferably, in addition to or instead of the audio file of the commercial, other information related to the merchandise advertised in the commercial is also downloaded, which can be in other forms such as a text file, a video file, etc. Thus, the requester can check the downloaded information about the advertised merchandise at a later time.

In a preferred embodiment, the request sent in response to the streaming commercial includes an order for purchasing the product or merchandise advertised in the commercial, with or without requesting downloading the commercial and/or related information. Upon receiving the request, the management server 30 may forward the order to a seller, together with shipping and/or billing information associated with the requester. The shipping and the billing information can be provided to the management server at the time the requester registers an account with the management server 30, or it can be stored in advance.

Usually the stream received at the receiver include both commercials and songs. In an embodiment, only the commercials are received together with identifiers each of which identifies a specific commercial or the product offered in the commercial. In this embodiment, the system is used for ordering products offered in the commercials but not for downloading the songs.

The above has described the preferred embodiments in downloading music scenario. However, it shall be understood that the present invention is equally applicable to downloading other types of streaming media such as speeches, TV programs, movies, video or multimedia, texts, etc.

For example, a TV set may be provided with a download button, and a TV watcher may actuate the button to send a request for downloading the TV program that he or she is watching. The request includes the identifier of the program, which may include the title, airing time, actors' names and/or the producer of the movie, etc. The request is transmitted from the TV set to a management server, and the requested program (which may be a movie) identified by the identifier is located at a database and downloaded to a temporary storage allocated by the management server, and finally downloaded to the computer of the requester. The downloaded TV program or movie may be in a superior DVD quality, which will be much better than the streaming one.

In a preferred embodiment, the TV station is a cable TV service provider that provides digital or HD programs. Preferably, the cable TV service provider maintains the management server as well as the media database. Upon actuation of the button on the TV set, the request is transmitted to the management server of the cable TV service provider over the cable.

In another preferred embodiment, the requester may request to download some component portions of the streaming multimedia. For example, the requester may request to download the caption or text of the TV program or movie only. Alternatively, the requester may request to download only the audio portion of the TV program or movie.

Therefore, it shall be understood that, without departing from the spirit of the present invention, numerous variations, adaptations and modifications are available to a person with ordinary skill in the art. For example, the management server 30 may incorporates a searching program to search the requested song or movie on Internet instead of going to a specific downloading service provider 400. Therefore, the scope of the present invention is intended to be solely defined by the accompanying claims.

What is claimed is:

1. A method for facilitating downloading media, comprising steps of:
receiving at a receiver a stream of media together with an identifier for each medium in the stream from a media station;
sending a request from said receiver to a management server for downloading one of said media in the stream, said request including said identifier of said requested medium; and
downloading said requested medium from a media database to a destination.

2. The method of claim 1, wherein said step of sending said request is carried out by activating a button provided on said receiver.

3. The method of claim 2, wherein said button is actuated when said requested medium is being played at said receiver.

4. The method of claim 1, wherein said request is sent to said management server over a data connection.

5. The method of claim 1, wherein said request is sent to said management server over a wireless network.

6. The method of claim 1, wherein said identifier of each medium comprises a title of said each medium.

7. The method of claim 6, wherein said identifier of each medium further comprises an artist's, an album's name and/or a producer's name of said each medium.

8. The method of claim 1, wherein said media station is an analog radio station, satellite radio station, HD radio station, an Internet radio station, an analog TV service provider, a satellite TV service provider, a cable TV service provider, an HD TV service provider, an online movie streaming server or an Internet multimedia station.

9. The method of claim 1, said receiving step further receives an identifier of said media station.

10. The method of claim 9, wherein said request further including said identifier of said media station.

11. The method of claim 10, wherein said media station is an analog media station, and said identifier of said requested medium is a time when said medium is played at said receiver.

12. The method of claim 11, wherein said media station maintains a playlist of said stream of media with a time schedule indicating when each of said media is being played.

13. The method of claim 12, wherein media database is maintained by said media station.

14. The method of claim 13, further comprising a step of forwarding said request to said media station.

15. The method of claim 1, said destination is a temporary storage maintained by said management server.

16. The method of claim 1, further comprising a step of forwarding said request from said management server to a downloading service provider that maintains said media database.

17. The method of claim 1, wherein said management server maintains said media database.

18. The method of claim 1, wherein said media station maintains said media database.

19. The method of claim 1, wherein said media station maintains said management server.

20. The method of claim 1, further comprising further comprising a step of authenticating said receiver by said management server.

21. The method of claim 1, said requested medium is a song, a movie, a TV program or a caption or text of a TV program or movie.

22. The method of claim 1, wherein said media station is a cable TV service provider, and said request is sent over a cable connection.

23. The method of claim 1, wherein said medium is a commercial.

24. The method of claim 23, wherein said request comprises an order for purchasing merchandise advertised in said commercial.

25. A system for facilitating downloading media, comprising:
a receiver for receiving, from a media station, a stream of media and an identifier for each of said media in the stream, said receiver comprising means for sending out a request for downloading one of said media in the stream, said request including said identifier identifying said requested medium;
a management server for receiving said request; and
a media database for transmitting said requested media to a destination.

26. The system of claim 25, wherein said media station is an analog radio station, satellite radio station, HD radio station, an Internet radio station, an analog TV service provider, a satellite TV service provider, a cable TV service provider, an HD TV service provider, an online movie streaming server or an Internet multimedia station.

27. The system of claim 25, wherein said identifier comprises a title of said each medium.

28. The system of claim 27, wherein said identifier for said each medium further comprises an artist's name, an album's name, and/or a producer's name of said each medium.

29. The system of claim 25, wherein said receiver comprises a button, and said request is sent out by actuating said button.

30. The system of clam 25, wherein said destination is a temporary storage maintained by said management server.

31. The system of claim 25, wherein said media database is maintained by a downloading service provider.

32. The system of claim 25, wherein said management server comprises means for forwarding said request to said downloading service provider.

33. The system of claim 32, wherein said downloading service provider is said media station from which said requested medium streamed to said receiver.

34. The system of claim 25, wherein said request further comprises an identifier identifying said media station.

35. The system of claim 34, wherein said media station is an analog media station, and said identifier of said medium is a time when said medium is received by said receiver.

36. The system of claim 35, wherein said media station maintains a playlist of said stream of media with a time schedule indicating when each of said media is being played.

37. The system of claim 36, wherein said management server comprising means for acquiring said playlist from said media station.

38. The system of claim 25, wherein said request is sent to said management server over a wireless network.

39. The system of claim 25, wherein said request is sent to said management server over a data connection.

40. The system of claim 39, wherein said management server comprising means for authenticating said receiver.

41. The system of claim 25, wherein said requested medium is a song, a movie, a TV program or a caption or text of a TV program or movie.

42. The system of claim 25, wherein said medium is a commercial.

43. The system of claim 42, wherein said request comprises an order for purchasing merchandise advertised in said commercial.

44. A receiver for receiving and playing a stream of media from at least one media station, comprising:
means for receiving an identifier for identifying each of said media in the stream from said media station; and
means for sending a request to a management server for downloading one of said media in the stream, said request including said identifier.

45. The receiver of claim 44, wherein said means for sending said request is a button, and said request is sent by actuating said button.

46. The receiver of claim 44, further comprising means for displaying said identifier.

47. The receiver of claim 44, further comprising means for receiving an identifier identifying said media station.

48. The receiver of claim 44, wherein said receiver is an audio stereo.

49. The receiver of claim 44, wherein said receiver is a computer.

50. The receiver of claim 44, wherein said receiver is a TV set.

51. The receiver of claim 44, wherein said media station is an analog radio station, satellite radio station, HD radio station, an Internet radio station, an analog TV service provider, a satellite TV service provider, a cable TV service provider, an HD TV service provider, an online movie streaming server or an Internet multimedia station.

52. The receiver of claim 44, wherein said identifier of each medium comprises a title, an artist's name, an album's name, and/or a producer's name.

53. The receiver of claim 44, wherein said identifier of each medium comprises a time when said medium is being played at said receiver.

54. The receiver of claim 44, wherein said receiver further comprises means for sending said request to said management server over a wireless network.

55. The receiver of claim 44, wherein said receiver further comprises means for sending said request to said management server over a data connection.

56. The receiver of claim 44, wherein said receiver further comprises means for sending said request to said management server over a TV cable.

57. The receiver of claim 44, wherein said receiver further comprises means for temporary save said identifiers of said media in the stream.

58. The receiver of claim 57, wherein said receiver comprises means for browsing and selectively deleting said temporarily saved identifiers.

59. A method for facilitating ordering products, comprising steps of:
receiving at a receiver a stream of a medium together with an identifier identifying said medium, said medium offering a product;
sending a request from said receiver to a management server for ordering said product offered in said medium, said request including said identifier of said medium;
in response to said request, consummating a sale of said product.

60. The method of claim 59, wherein said medium is a commercial streamed from a radio station.

61. The method of claim 59, wherein said medium is a commercial streamed from a TV service provider.

62. The method of claim 59, wherein said step of consummating the sale comprises a step of forwarding said request to a seller, together with shipping and/or billing information associated with a requester.

63. The method of claim 59, wherein said stream of said medium is received among a stream of other media that do not offer any product.

64. A system for facilitating ordering products, comprising:
a receiver for receiving a stream of a media offering a product together with an identifier, said receiver comprising means for sending out a request for ordering said product offered in said media, said request including said identifier identifying said media;
a management server for receiving said request and for consummating a sale of said product in response to said request.

65. The system of claim 64, wherein said receiver comprises a button, and said request is sent upon actuating said button.

66. The system of claim 64, wherein said management server comprises means for forwarding said request to a seller together with shipping and/or billing information associated with a requester.

67. The system of claim 64, wherein said stream of said media is received with other information that does not affect ordering the product.

68. The system of claim 64, wherein said stream of said media is received from a radio or TV station.
